(19) United States
(12) Patent Application Publication
(10) Pub. No.: US 2004/0147781 A1
(43) Pub. Date: Jul. 29, 2004

(54) Process for producing organic amine borane compounds

(75) Inventors: Yi-Jung Huang, Taoyuan County (TW); Chih-Chiang Chen, Taoyuan County (TW); Chun-Yuan Su, Taoyuan County (TW); Yi-Ching Lin, Taoyuan County (TW)

Correspondence Address: BACON & THOMAS, PLLC, 625 SLATERS LANE, FOURTH FLOOR, ALEXANDRIA, VA, 22314

(73) Assignee: Kuo Ching Chemical Co., Ltd., Taoyuan County (TW)

(21) Appl. No.: 10/350,056

(22) Filed: Jan. 24, 2003

(51) Int. Cl. C07F 5/02

(52) U.S. Cl. 564/9

(57) ABSTRACT

The invention provides an improved process for preparing organic amine borane complex characterized in that it takes advantage of the slow reaction of potassium borohydride with water and the increased solubility in an ether/water mixed solvent containing minor amount of sodium hydroxide, adding slowly an organic amine to control the reaction rate and effectively control the generation of hydrogen gas in a manner to increase the yield and ensure the process safety.

### BACKGROUND OF THE INVENTION

1. Field of the Invention

The invention relates to an improved process for producing organic amine borane complex of high purity.

2. Description of the Related Prior Art

Organic amine borane complex has been used extensively in a variety of industries, such as reducing agent, printed circuit board and the like. In the printed circuit board industry, reducing agents commonly used include sodium hypophosphite, hydrazine, dimethylamine borane (DMAB), diethylamine borane (DEAB), sodium borohydride and the like. Among them, for the black oxide process usually used in manufacturing of a printed circuit board, DMAB and tri-(methylamino)-boron are main reducing agents used.

For the synthesis of the organic amine borane complex, a conventional process consists of reacting sodium borohydride (NaBH₄) with a dimethylammonium salt as depicted in the following equation:

NaBH₄+(CH₃)₂NH.HCl→(CH₃)₂NH:BH₃+NaCl+H₂

Organic amine borane compound is a reducing agent of mild reactivity and is compatible with most organic solvents. It can be used extensively in solvent of types of aldehyde, ketone, quinone and the like. Moreover, it can be used for carrying out reduction reaction even in an acidic condition, for example, for reducing C═N double bond in acetic acid. It is suitable for alkali-sensitive substances. Accordingly, it has superior applicability than sodium borohydride. Current synthesis process for organic amine borane complex consists mainly of those carried out in organic solvents such as tetrahydrofuran (THF), 1,2-dimethoxyethane and the like, in which sodium borohydride and dimethylamine are added at a low temperature. Since sodium borohydride has poor solubility in organic solvents, a solid/liquid biphasic reaction is resulted, which produces slowly the desired amine borane complex and salts. Further, such heterogeneous reaction not only takes longer reaction time (ca. 2 to 3 days), but its post-treatment may also affect the purity and yield of the desired amine borane complex. For example, JP 158792 (1981) disclosed a process wherein, after the reaction, 1,2-dimethoxyethane was removed at first, then the amine borane compound was dissolved in dichloromethane or toluene, salts were filtered off and the organic solvents were vaporized off to give the produce. Unfortunately, this process produced a product with low yield and of poor purity.

In addition to the problem of solubility in organic solvent, there is a side reaction in which tetrahydrofuran reacts with BH₃ into a THF:BH₃ complex.

This side reaction can affect the reaction rate, lead to an excessive residual amount of dimethylamine salt and hence influences the purity of the product. JP 5112577 (1993) disclosed a process for increasing the purity of the product by reacting the residual amine salts in the filtrate obtained after filtering off most of salts with 0.1% aqueous sodium hydroxide and minor amount of sodium borohydride, and subsequently vaporized off the organic solvent to yield the desired product. However, such process is a vigorous reaction due to the acid/base neutralizing reaction involved in that treating procedure.

As for the reaction rate problem due to the solubility, Russian researchers in 1986 reported a solvent-less process using ball mill by reacting sodium borohydride or potassium borohydride directly with amine salts and JP 5112579 in 1993 disclosed a process using microwave to promote the reaction rate; however, products prepared by these processes were not practicable in the industry.

In 1993, JP 5097866 disclosed a process for preparing amine borane complex by using a mixed THF/H₂O system for increasing solubility in order to address the problem of the slow reaction rate caused by low solubility in organic solvent. However, since water could react with sodium borohydride increased usage of sodium borohydride (1.2 to 1.4 equivalents) is required for compensating that side reaction of water with sodium borohydride.

JP 10109991 in 1997 disclosed a process for preparing amine borane complex by using anhydrous ether, 1,2-dimethoxyethane, instead of tetrahydrofuran for increasing the solubility of sodium borohydride as well as for lowering the side coordination reaction with BH3 due to the increased steric hindrance associated with this ether. In this process, after the completion of the reaction, the organic solvent was distilled off, water was added to the residues to completely dissolve salts in the reaction mixture as well as form a two phase liquid of an organic layer and a aqueous layer, the aqueous layer was removed, and the residual 1,2-dimethoxyethane in the organic layer was distilled off to yield dimethylamine borane complex. However, during the distillation, the high boiling 1,2-dimethoxyethane tended to cause a side reaction of dimethylamine borane complex as follows:

(CH₃)₂NH:BH₃→CH₃N═BH₂+H₂

As for the problem of impurities, mention can be made of purification by crystallization, such as in a process disclosed in U.S. Pat. No. 6,060,623, after distilling off 1,2-dimethoxyethane, 5% aqueous sodium hydroxide solution was added to remove impurities and gave a yield of 85% and purity of 99%.

Again, with respect to the solubility problem, a process disclosed by Bayer in U.S. Pat. No. 5,565,615 (1996) used dimethylamine (DMA) instead as organic solvent and effectively solved the problem for dissolving sodium borohydride and amine salts, and then added drop-wise slowly acetic acid or sulfuric acid to synthesize DMAB. In this process, an exothermic acid/base neutralization reaction was carried out initially:

CH₃COOH+(CH₃)₂NH→(CH₃)₂NH₂.CH₃COO

Thereafter, the salt generated in situ was reacted with sodium borohydride:

NaBH₄+(CH₃)₂NH₂.CH₃COO→(CH₃)₂NH:BH₃+CH₃COONₐ+H₂

Since dimethylamine is a substance of low boiling point (9° C.), the escape of hydrogen gas (H₂) generated could carry dimethylamine easily out of the reaction system resulting in the gradual decrease of the solvent. Furthermore, the heat generated due to the neutralization could elevate the temperature of the reaction system from 5° C. to 32° C. in a very short time, which tended more easily to vaporize dimethylamine. Further, although the reaction time can be shortened, the amount of gas generated could not be controlled easily. In addition, for the recovery of dimethylamine, a cooling system having good performance should be required; otherwise, there might be a safety problem.

A process for preparing organic amine borane complex is desirable without the above-described prior art problems, i.e. reaction rate problem due to solubility as well as the safety problem.

### SUMMARY OF THE INVENTION

Accordingly, the object of the invention is to provide a process for preparing organic amine borane complex characterized in that it consists of using potassium borohydride as the main reactant in a water-containing ether solvent, adding slowly an organic amine to control the reaction rate and effectively control the generation of hydrogen gas, removing solvent under reduced pressure, filtering off salts, purifying by washing with water and drying to give the desired product with high purity.

### DETAILED DESCRIPTION OF THE PREFERRED EMBODIMENTS

As described above, the invention provides a process for preparing organic amine borane complex consisting of using potassium borohydride (KBH4) as the main reactant instead of sodium borohydride and reacting with dimethylamine

NaBH₄+(CH₃)₂NH.HCl→(CH₃)₂NH:BH₃+NaCl+H₂

Since potassium borohydride is thermodynamically more stable than sodium borohydride, the prior art employed preferentially sodium borohydride to prepare amine borane complex. In the case of using tetrahydrofuran as solvent to carry out such type of reaction, it can be found that, in a same reaction time frame, the reaction rate achieved by using potassium borohydride is only 1/10 of that by using sodium borohydride.

The process according to the invention takes advantage of, instead, this feature of low reactivity of potassium borohydride to water since potassium borohydride is capable to form with water at a low temperature (−10° C.) into a compound having three molecules of crystallization water, and thereafter, water is released gradually as the temperature is raised:

$${KBH}_{4} + 3 {H}_{2} O {\to }^{- 10 ° C .} {KBH}_{4} \cdot 3 {H}_{2} O {\to }^{7.3 ° C .} {KBH}_{4} \cdot {H}_{2} O + 2 {H}_{2} O$$

At about 7.3° C., there remains still one crystallization water, whereas sodium borohydride can form a compound having only two crystallization water that decomposes quickly. This is why the process disclosed in JP5097866 had to increase the amount of sodium borohydride to compensate that consumed through the side reaction of water with sodium borohydride.

The invention takes advantage of the feature that potassium borohydride reacts slowly with water but exhibits higher stability compared with sodium borohydride, and thus overcomes the solubility problem by using a solution of tetrahydrofuran and water. This approach according to the invention not only can promote effectively the reaction rate, but also needs not use excessive amount of potassium borohydride. In the course of the reaction, the amount of hydrogen gas generated can be controlled by the feeding rate of the organic amine so that the yield can be increased and a safe production can be ensured.

On the other hand, if the feature of slow reactivity with water and the relative safety could be enhanced, the yield of the reaction would be raised effectively further. In view of this, in the process according to the invention, minor amount of sodium or potassium hydroxide is added to the mixed solvent of tetrahydrofuran and water to make the solution alkaline that can inhibit effectively the decomposition of potassium borohydride. Further, for the sodium borohydride that tends to decompose easily, this can increase its reaction yield remarkably without compensation of excessive amount of sodium borohydride.

In another aspect of the process according to the invention, methanol is used to replace part of water to lower the decomposition rate of potassium borohydride or sodium hydroxide. However, it is not convenient to recover and recycle the individual solvent in this three-solvent system. If a solvent system consisted simply of tetrahydrofuran and water is used in the reaction system, the recovered water-containing tetrahydrofuran needs not further special treatment but only the addition of appropriate amount of water or tetrahydrofuran to the required ratio and then reused in the reaction without affecting the quality of the product.

The features and technique aspects will be further described in more details with reference to the following illustrative, non-limiting examples.

### EXAMPLE 1

In a 1-liter four-necked double layer flask equipped with a cryometer, a condenser, and a mechanical stirrer, 400 ml of tetrahydrofuran and 4 g of sodium hydroxide were added. After the temperature of the mixture was lowered to −10° C., 121.83 g of potassium borohydride was added in the flask and then 175 g of dimethylammonium chloride dissolved in 140 ml of water was added portion-wise while the temperature was controlled below 10° C. and the feeding rate was controlled based on the amount of the gas generated (<200 cc/min). Once the addition of the aqueous dimethylammonium chloride solution was complete, the reaction was continued at a temperature below 15° C. for 10 to 14 hours. The endpoint of the reaction was determined as the generation of gas was ceased.

At the end of the reaction, the reaction mixture was filtered through a Buchner funnel with an adapted filtering flask. The resulted white salt was washed by suspending in 120 ml of tetrahydrofuran and re-filtering until not dropping anymore. The combined solution of the two filtrates was distilled under reduced pressure to recover tetrahydrofuran. The resulted DMAB was washed once with 20 ml water. After the lower water layer was separated off to remove impurities, 108.5 g of DMAB was obtained at a yield of 85% and with a purity of 99%.

The content of metal ion in DMAB thus obtained was analyzed with ICP mass spectrometer and gave a potassium ion content of 148 ppm and a sodium ion content of 28 ppm.

### EXAMPLE 2

In a 1-liter four-necked double layer flask equipped with a cryometer, a condenser, and a mechanical stirrer, 500 ml of a mixed solvent of tetrahydrofuran and water (v/v=4/1) and 4 g of sodium hydroxide were added.

After the temperature of the mixture was lowered to −10° C., 121.83 g of potassium borohydride was added in the flask and then 175 g of dimethylammonium chloride was added portion-wise while the temperature was controlled below 10° C. and the feeding rate was controlled based on the amount of the gas generated (<200 cc/min). Once the addition of dimethylammonium chloride was complete, the reaction was continued at a temperature below 15° C. for 10 to 14 hours. The endpoint of the reaction was determined as the generation of gas was ceased.

At the end of the reaction, the reaction mixture was filtered through a Buchner funnel with an adapted filtering flask. The resulted white salt was washed by suspending in 120 ml of tetrahydrofuran and re-filtering until not dropping anymore. The combined solution of the two filtrates was distilled under reduced pressure to recover tetrahydrofuran. The resulted DMAB was washed once with 20 ml water. After the lower water layer was separated off to remove impurities, 104.7 g of DMAB was obtained at a yield of 82% and with a purity of 99%.

### EXAMPLE 3

The procedure as described in Example 1 was repeated except that the amount of potassium borohydride was changed into 85 g. After treated with same manner, 69 g DMAB was obtained at a yield of 54% and with a purity of 97%.

### EXAMPLE 4

The procedure as described in Example 2 was repeated except that the amount of potassium borohydride was changed into 85 g. After treating with same manner, 93.8 g DMAB was obtained at yield of 73% and with a purity of 98%.

### EXAMPLE 5

The procedure as described in Example 2 was repeated except 500 ml of a mixed solvent of 1,2-dimethoxyethane and water (v/v=4/1) was used instead of the mixed THF/water solvent. After the temperature of the mixture was lowered to −5° C., 121.83 g of potassium borohydride was added in the flask and then 175 g of dimethylammonium chloride was added portion-wise while the temperature was controlled below 10° C. and the feeding rate was controlled based on the amount of the gas generated (<250 cc/min). Once the addition of potassium borohydride was complete, the reaction was continued at a temperature below 15° C. for 6 to 10 hours. The endpoint of the reaction was determined as the generation of gas was ceased.

At the end of the reaction, the reaction mixture was filtered through a Buchner funnel with an adapted filtering flask. The resulted white salt was washed by suspending in 120 ml of 1,2-dimethoxyethane and re-filtering until not dropping anymore. The combined solution of the two filtrates was distilled under reduced pressure to recover 1,2-dimethoxyethane. The resulted DMAB was washed once with 20 ml 5% NaOH. After the lower water layer was separated off to remove impurities, 70.4 g of DMAB was obtained at a yield of 55.1% and with a purity of 99%.

### EXAMPLE 6

The procedure as described in Example 2 was repeated except 500 ml of a mixed solvent of tetrahydrofuran and water (v/v=4/1) containing 4 g sodium hydroxide was changed into a mixed solvent of 1,2-dimethoxyethane and water containing 4 g sodium hydroxide. After the temperature of the mixture was lowered to −5° C., 121.83 g of potassium borohydride was added in the flask and then 175 g of dimethylammonium chloride added portion-wise while the temperature was controlled below 10° C. and controlling the feeding rate based on the amount of the gas generated (<250 cc/min). Once the addition of potassium borohydride was complete, the reaction was continued at a temperature below 15° C. for 6 to 10 hours. The endpoint of the reaction was determined as the generation of gas was ceased.

At the end of the reaction, the reaction mixture was filtered through a Buchner funnel with an adapted filtering flask. The resulted white salt was washed by suspending in 120 ml of 1,2-dimethoxyethane and re-filtering until not dropping anymore. The combined solution of the two filtrates was distilled under reduced pressure to recover 1,2-dimethoxyethane. The resulted DMAB was washed once with 20 ml 5% NaOH. After the lower water layer was separated off to remove impurities, 83 g of DMAB was obtained at a yield of 65% and with a purity of 99%.

What is claimed is:

1. A process for preparing organic amine borane complex characterized in that it consists of using potassium borohydride as the main reactant.

2. A process as recited in claim 1, characterized in that it comprises steps of dissolving potassium borohydride in a water-containing ether solvent, adding slowly an organic amine salt to control the reaction rate and effectively control the generation of hydrogen gas, removing solvent under reduced pressure, filtering off salts, purifying by washing with water and drying to give the desired product.

3. A process as recited in claim 1, characterized in that said organic amine borane complex is dimethylamine borane complex.

4. A process as recited in claim 2, characterized in that said organic amine salt is dimethylamine salt.

5. A process as recited in claim 2, characterized in that said ether solvent is tetrahydrofuran, ether or 1,2-dimethoxyethane.
